(19) United States
(12) Patent Application Publication
(10) Pub. No.: US 2004/0032043 A1
(43) Pub. Date: Feb. 19, 2004

(54) Integral core puller/mold technology

(76) Inventors: Michael E. Woolford, Lake Elmo, MN (US); Mike Bastyr, Clear Lake, WI (US); Mark Glumske, Osceola, WI (US)

Correspondence Address: JOEL D. SKINNER, JR., SKINNER AND ASSOCIATES, 212 COMMERCIAL ST., HUDSON, WI, 54016, US

(21) Appl. No.: 10/219,133

(22) Filed: Aug. 15, 2002

(51) Int. Cl. B28B 1/08

(52) U.S. Cl. 264/71; 425/424; 425/425

(57) ABSTRACT

A core puller/mold assembly includes a mold frame containing a block mold having a mold cavity. A pair of cylinders is present, with each cylinder fastened to an opposed, exterior side of the mold frame. The cylinders each have a rod that extends beyond the mold frame joining the opposed, exterior sides. A core bar mounting bracket is fastened between the cylinder rods. At least one core bar is secured to the mounting bracket, with the bar extending toward the mold cavity. The at least one core bar is removed from the mold cavity with the cylinder rods extended and traverses the mold cavity with the cylinder rods retracted. The following attorney's file path identification forms no part of the disclosure or claims of

### CROSS-REFERENCE TO RELATED APPLICATIONS, IF ANY

Not applicable.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention.

The present invention relates, generally, to a core puller for molds used in conjunction with concrete block manufacture. More particularly, the invention relates to an integral core puller/mold assembly. Most particularly, the invention relates to a system, apparatus and method for the rapid pulling of cores from a compact, automatic, integral core puller/mold assembly.

2. Background Information.

The background technology, in general, includes apparatus and/or methods for pulling core bars or similar devices from a mold used to form a concrete block. High production concrete block machines operate rapidly and in those instances in which multiple blocks are molded with grooved lower faces, it is necessary to provide multiple core parts which can be retraced from the molds at high speed to permit the newly molded blocks to be stripped from the molds and lowered by pallet onto a conveyor for transportation to curing or storage.

In the past, core pullers have been used which provide a single, heavy duty ram having a header actuated by the hydraulic ram and carrying multiple core bars which are inserted into, and retracted from, the molds. Such core pullers are heavy, bulky and require much space. In general, the devices are custom manufactured to suit a particular block machine and are not readily adapted for use with other block machines.

Machines of this type tend to be subject to guidance problems with respect to the elongate core bars and to vibration problems resulting from intense vibration of the block machine during the molding process. The use of a single hydraulically operated ram results in a relatively slow acting core puller assembly that interferes with normal production.

Other core pullers employ multiple hydraulic rams to achieve core pulling during production. All of these core pullers are provided as “add-on” attachments that require extra space and precise alignment with the mold to achieve satisfactory results.

This technology is believed to have significant limitations and shortcomings, including, but not limited to:

a. Large space requirements for the “add-on” attachment.

b. Precise alignment requirements for proper function.

c. Extended setup time when changing molds.

For this and other reasons, a need exists for the present invention.

The invention provides an integral core puller/mold assembly, which is believed to fulfill the need and to constitute an improvement over the background technology.

All US patents and patent applications and all other published documents mentioned anywhere in this application are incorporated by reference in their entirety.

### BRIEF SUMMARY OF THE INVENTION

The present invention provides an apparatus and method for molding concrete blocks employing a block molding system.

In one embodiment, the apparatus includes a core puller/mold assembly comprising a mold frame containing a block mold having a mold cavity. A pair of cylinders is present, with each cylinder fastened to an opposed, exterior side of the mold frame. The cylinders each have a rod that extends beyond the mold frame joining the opposed, exterior sides. A core bar mounting bracket is fastened between the cylinder rods. At least one core bar is secured to the mounting bracket, with the bar extending toward the mold cavity. The at least one core bar is removed from the mold cavity with the cylinder rods extended and traverses the mold cavity with the cylinder rods retracted.

In another embodiment, the apparatus includes a core puller/mold assembly comprising a mold frame containing a block mold having a mold cavity. A top plate member with a mold cavity aperture therein, is secured atop the mold frame. A pair of cylinders is present, each cylinder fastened to an opposed, exterior side of the mold frame. The cylinders each have a rod extending beyond the mold frame joining the opposed, exterior sides, with the cylinder rods passing through a rod aperture in the mold frame. The cylinder rods are perpendicular to the vertical, interior sides of the cavity. A core bar mounting bracket is fastened between the cylinder rods. At least one core bar is reversibly secured to the mounting bracket and extends toward the mold cavity through a core bar aperture in the mold frame. The at least one core bar is removed from the mold cavity with the cylinder rods extended and traverses the mold cavity with the cylinder rods retracted.

The method of molding a block includes the steps of providing a core puller/mold assembly comprising a mold frame containing a block mold having a mold cavity. A pair of cylinders is present, with each cylinder fastened to an opposed, exterior side of the mold frame. The cylinders each have a rod that extends beyond the mold frame joining the opposed, exterior sides. A core bar mounting bracket is fastened between the cylinder rods. At least one core bar is secured to the mounting bracket, with the bar extending toward the mold cavity.

The cylinder rods are retracted with the at least one core bar traversing the mold cavity. The mold is filled with fill mix, vibrated and pressure applied, to form the block within the mold. The at lease one core bar is removed from the mold by extending the cylinder rods. The block is removed from the mold by vertical movement of a plunger assembly through the mold cavity.

The features, benefits and objects of the invention will become clear to those skilled in the art by reference to the following description, claims and drawings.

### BRIEF DESCRIPTION OF THE SEVERAL VIEWS OF THE DRAWING

FIG. 1 is a perspective view of the core puller/mold assembly of the present invention.

FIG. 2 is a perspective view of the core puller/mold assembly of FIG. 1 with the top plate member removed.

FIG. 3 is an exploded perspective view of the core puller/mold assembly of FIG. 1.

FIG. 4 is a schematic representation of a block machine incorporating the core puller/mold assembly of the present invention.

FIG. 5 is a perspective view of the plunger assembly used to remove a block from the core puller/mold assembly of the present invention.

### DETAILED DESCRIPTION

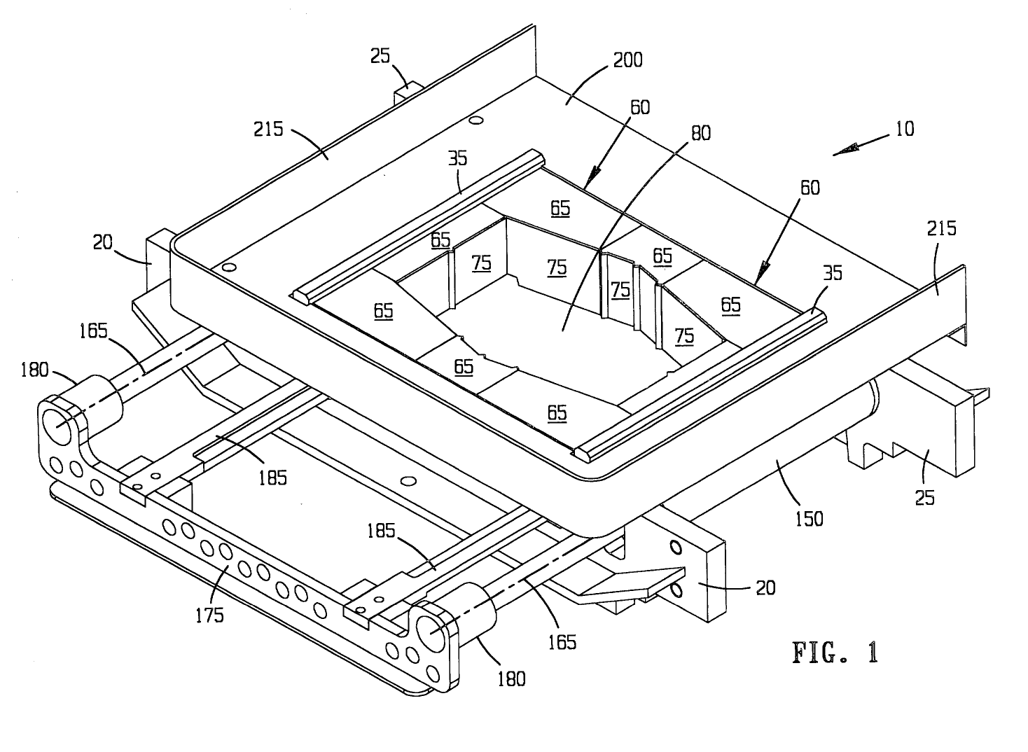

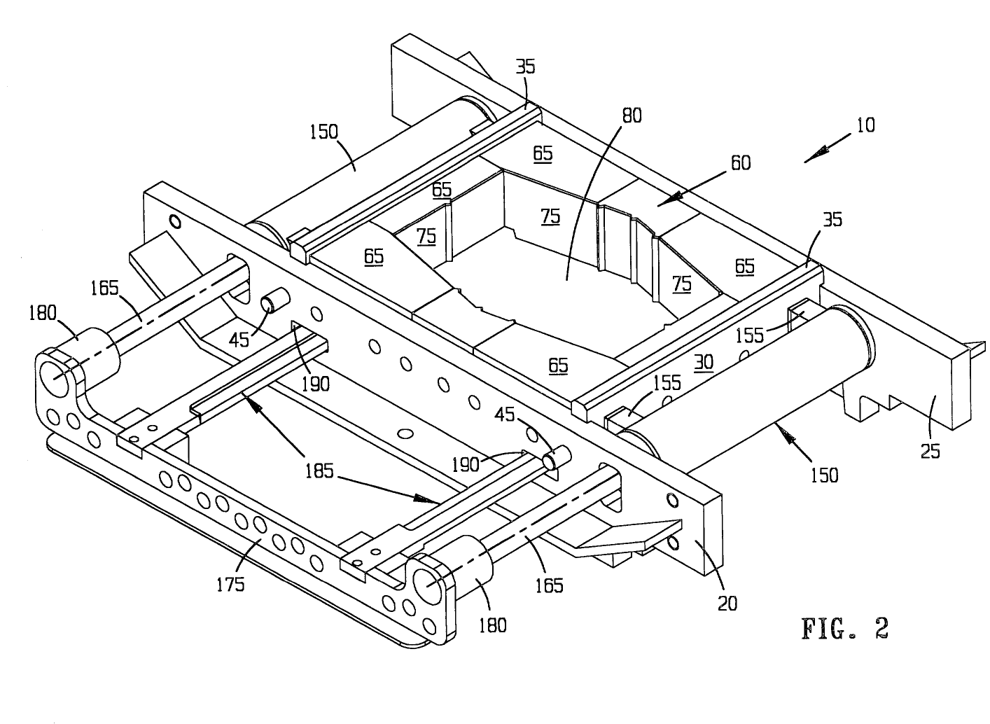

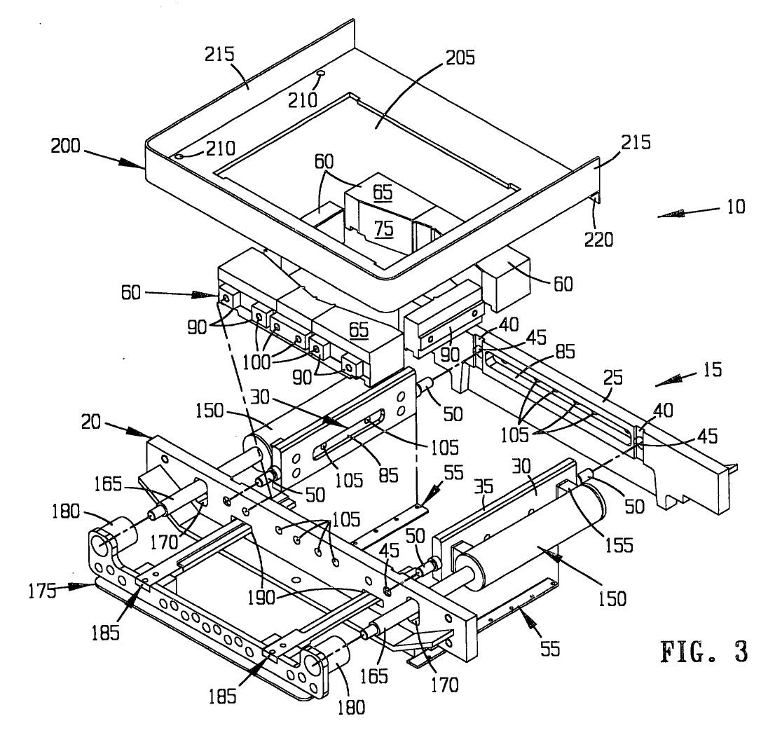

FIGS. 1-3 show an embodiment of the present invention, generally indicated by the reference numeral 10. The assembly 10 is shown fully assembled in FIG. 1 and with the top plate member 200 removed in FIG. 2. FIG. 3 provides an exploded view of the assembly 10 of FIG. 1, in which a generally rectangular mold frame 15 is composed of a side bar member 20, an opposed stop bar member 25 and a pair of spaced apart, outside division plate members 30, each having a top edge 35. The components of the mold frame 15 are each generally rectangular and secured together with each end of the side bar member 20 and stop bar member 25 extending beyond the plane of attachment of each of the two division plate members 30. The side bar member 20 and stop bar member 25 each has a pair of vertical retaining slots 40, each slot 40 with a slot aperture 45 therein. The division plate members 30 include a retaining peg 50 at each end. Each plate member end fits into one of the retaining slots 40 with the retaining peg 50 inserted into the slot aperture 45. The bar members 20, 25 and plate members 30 are further secured together by retainer straps 55, secured between the bar members 20, 25 beneath each plate member 30.

The mold frame 15 is sized to accept a plurality of wear liners 60 that define the concrete block produced by the core puller/mold assembly 10. The wear liners 60 are fabricated from steel alloy for strength and resistance to abrasion by the concrete fill used to produce each block. The wear liners 60 have planar top 65 and bottom 70 surfaces and fit together within the mold frame 15, such that the liner interior surfaces 75 define a mold cavity 80 that produces the concrete block. The mold cavity 80 is open at both the top and bottom, with vertical interior surfaces 75.

The interior surface of the bar members 20, 25 and plate members 30 each contain a horizontal channel 85. The wear liners 60 are provided with alignment ridges 90 on their exterior surfaces 95, which fit into the horizontal channels 85 of the bar members 20, 25 and plate members 30. Additionally, the alignment ridges 90 are provided with a number of threaded blind holes 100 that align with apertures 105 in the channels 85 for securing the various wear liners 60 to the bar member 20, 25 and plate members 30 with threaded fasteners (not shown). Thus, the mold frame 15 and associated wear liners 60 provide a structurally rigid mold portion that is easily disassembled for changing wear liners 60 to produce various shaped concrete blocks.

An actuation cylinder 150 is secured horizontally to an exterior side of each division plate member 30. Each actuation cylinder 150 is secured thereto, by a pair of cylinder mounts 155 and associated mount spacers 160. The actuation cylinders 150 are sized to fit between the ends of the bar members 20, 25 that extend beyond each division plate member 30. Each actuation cylinder 150 has a moveable rod member 165, extending from one end thereof, through a rod aperture 170 in the side bar member 20. The cylinder rod members 165 are fastened to a core mounting bracket member 175 via rod connectors 180 at each end of the bracket member 175.

At least one core bar member 185 is fastened at one end to the bracket member 175. In this embodiment, two core bar members 185 are fastened to the bracket member 175, with the core bar member 185 extending through a core slot 190 in the side bar member 20. The bracket member 175 and core slot 190 are positioned so as to direct the core bar member 185 along one surface of the block mold. In this embodiment, each core bar member 185 traverses the mold cavity 80 at opposite ends thereof, adjacent the top plate member 200. The cylinder rod members 165 and core bar members 185 are sized so that, with the cylinder rod members 165 extended from the cylinders 150, the core bar members 185 are completely removed from the mold cavity 80, and with the cylinder rod members 165 retracted into the cylinders 150, the core bar members 185 extend completely across the mold cavity 80. The core bar members 185 are, preferably, reversibly fastened to the bracket member 175 should replacement of the core bar members 185 be required.

To further reinforce the core puller/mold assembly 10, a top plate member 200 is secured atop the mold frame 15. The top plate member 200 is planar with a core aperture 205 sized to be larger than the open top of the mold interior cavity 80. The top plate core aperture 205 is sized to allow the division plate members top edges 35 to extend there through, along opposed edges thereof. The top plate member 200 also includes apertures 210 for fastening the plate member 200 to the side bar and stop bar members 20, 25 for added structural stability. The top plate member 200 also includes upwardly extending edges 215 on three sides and a downwardly extending fourth edge 220 for low level access to the open top of the mold cavity 80.

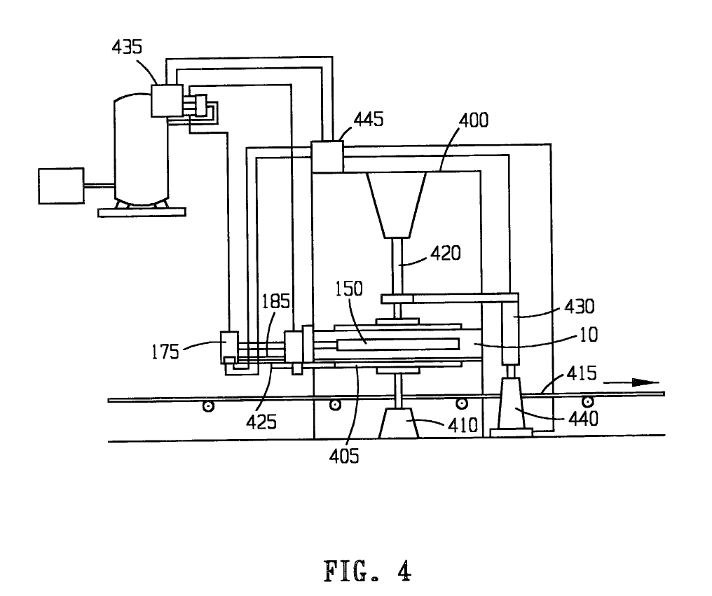

A block machines of the type with which the core puller/mold assembly 10 is used is shown schematically in FIG. 4. The block machine 400 is supplied with pallets 405 by a conveyor 415. The pallets 405 are raised into position, as by a lower lift unit 410. The molds are filled by a metering chute (not shown) and an upper stripper head unit 420, having a movable height pin 430 connected thereto, which is lowered into position until the height pin 430 engages a relatively fixed height pin 440. The height pins 430 and 440 determine the height of the blocks and also provide electrical contacts, which close to initiate termination of the vibration cycle and also actuate the stripping action of the head unit 420 by way of the delay timer 445. The delay timer 445 also sends a signal to the core puller/mold assembly 10, so that the core bars 185 are retracted prior to the stripping action. The safety switch actuator 425 mounted to the core bar mounting bracket 175 of the assembly 10 is incorporated into the block machine circuitry to preclude stripping of the mold cavity 80 until the safety switch 425 is closed.

The sequence of operation begins with the core bars 185 fully extended into the mold cavity 80. When the core bars 185 are in place in the mold assembly 10, a pallet member 405 is moved into position below the cavity 80. Following this, the mold cavity 80 fills with concrete, and vibration of the block machine commences. Engagement of the height pins 430 and 440 initiates termination of vibration. Prior to the complete termination of vibration, the block machine delay timer 445, actuated by engagement of the height pins 430, 440, sends a signal to the drive unit timer 435, which actuates the air supply to the cylinders 150. The core bars 185 are retracted, when drive unit timer 435 times out, by supplying air to the cylinder front air inlets at the same time as the vibration is completed, since stripping action begins very shortly, about four-tenths (4/10) of a second, after completion of vibration. The completed blocks are lowered with the pallet member 405 and transported by the conveyor 415 to storage or curing. When the drive unit timer 435 again times out, air is supplied to the cylinder rear air inlets, and the core bars 185 re-enter the mold assembly liner cavity 80 shortly before another pallet member 405 is raised into position for the next cycle.

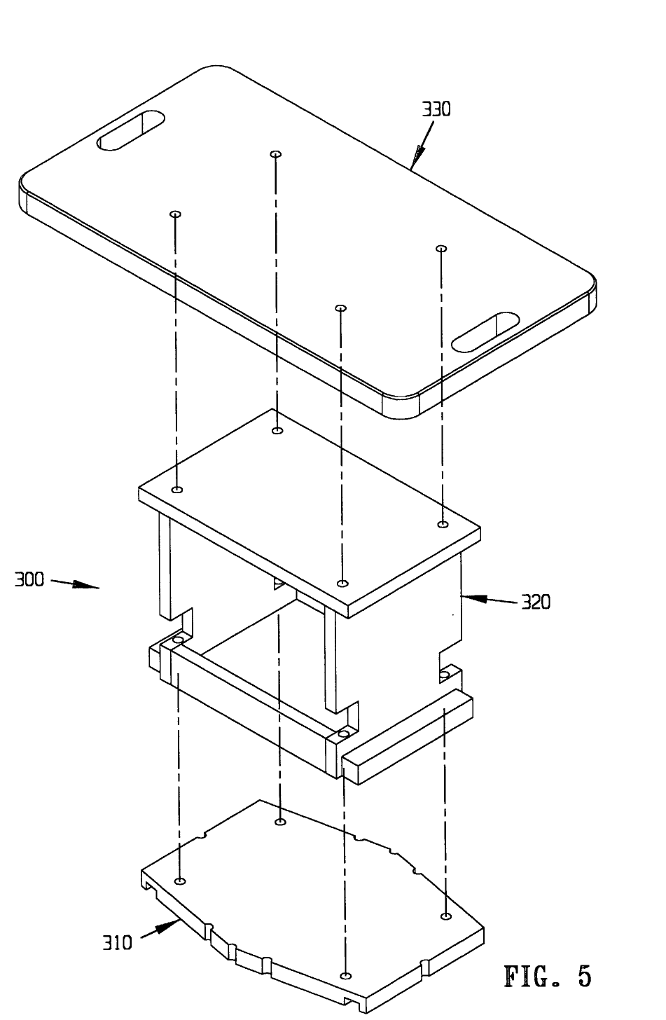

The plunger assembly 300 used to remove the formed block from the core aperture 80 of the core puller/mold assembly 10 is shown in FIG. 5. The plunger assembly 300 is positioned above the block-filled core aperture 80 with the stripper shoe 310 contacting the block upper surface. The downwardly extending edge 220 of the top plate member 200 provides clear, low-level access for the plunger assembly 300 to the top of the mold assembly 10. The stripper shoe 310 is configured to match the core aperture 80, such that downward movement of the plunger assembly 300 strips the block cleanly from the mold cavity 80. The stripper shoe 310 is secured to a plunger weldment 320 which, in turn, is fastened to a head plate 330. The plunger weldment 320 footprint is smaller than the stripper shoe 310, so as to pass into the mold cavity 80 without contacting the vertical surfaces 75 of the mold. The head plate 330 provides for attachment of the plunger assembly 300 to the stripper head unit 420 of the block machine 400.

The descriptions above and the accompanying drawings should be interpreted in the illustrative and not the limited sense. While the invention has been disclosed in connection with an embodiment or embodiments thereof, it should be understood that there may be other embodiments which fall within the scope of the invention as defined by the claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A core puller/mold assembly comprising:
(a) a mold frame containing a block mold having a mold cavity;
(b) a pair of cylinders, each cylinder fastened to an opposed, exterior side of the mold frame, the cylinders each having a rod extending beyond the mold frame joining the opposed, exterior sides;
(c) a core bar mounting bracket fastened between the cylinder rods; and
(d) at least one core bar secured to the mounting bracket and extending toward the mold cavity, whereby the at least one core bar is removed from the mold cavity with the cylinder rods extended and traverses the mold cavity with the cylinder rods retracted.

2. The core puller/mold assembly of claim 1, further including a top plate member with a mold cavity aperture therein, the top plate member secured atop the mold frame.

3. The core puller/mold assembly of claim 1, wherein the block mold comprises a plurality of wear liners secured within the mold frame to produce the mold cavity.

4. The core puller/mold assembly of claim 1, wherein each cylinder rod passes through a rod aperture in the mold frame.

5. The core puller/mold assembly of claim 1, wherein the at least one core bar travels in a core bar aperture in the mold frame.

6. The core puller/mold assembly of claim 1, wherein the at least one core bar is positioned adjacent one surface of the block mold.

7. The core puller/mold assembly of claim 1, wherein two core bars are secured to the core bar mounting bracket.

8. The core puller/mold assembly of claim 1, wherein the at least one core bar is reversibly secured to the mounting bracket.

9. The core puller/mold assembly of claim 1, wherein the mold cavity includes vertical interior surfaces with top and bottom openings.

10. The core puller/mold assembly of claim 9, wherein the cylinder rods are perpendicular to the mold cavity vertical interior surfaces.

11. A core puller/mold assembly comprising:
(a) a mold frame containing a block mold having a mold cavity with vertical interior surfaces and open top and bottom;
(b) a pair of cylinders, each cylinder fastened to an opposed, exterior side of the mold frame, the cylinders each having a rod extending beyond the mold frame joining the opposed, exterior sides, the cylinder rods perpendicular to the cavity vertical interior sides;
(c) a core bar mounting bracket fastened between the cylinder rods; and
(d) at least one core bar secured to the mounting bracket and extending toward the mold cavity, whereby the at least one core bar is removed from the mold cavity with the cylinder rods extended and traverses the mold cavity with the cylinder rods retracted.

12. The core puller/mold assembly of claim 11, further including a top plate member with a mold cavity aperture therein, the top plate member secured atop the mold frame.

13. The core puller/mold assembly of claim 11, wherein the block mold comprises a plurality of wear liners secured within the mold frame to produce the mold cavity.

14. The core puller/mold assembly of claim 11, wherein each cylinder rod passes through a rod aperture in the mold frame.

15. The core puller/mold assembly of claim 11, wherein the at least one core bar travels in a core bar aperture in the mold frame.

16. The core puller/mold assembly of claim 11, wherein the at least one core bar is positioned adjacent one surface of the block mold.

17. The core puller/mold assembly of claim 11, wherein two core bars are secured to the core bar mounting bracket.

18. The core puller/mold assembly of claim 11, wherein the at least one core bar is reversibly secured to the mounting bracket.

19. A core puller/mold assembly comprising:
(a) a mold frame containing a block mold having a mold cavity with vertical interior surfaces and open top and bottom;
(b) a top plate member with a mold cavity aperture therein, the top plate member secured atop the mold frame;
(c) a pair of cylinders, each cylinder fastened to an opposed, exterior side of the mold frame, the cylinders each having a rod extending beyond the mold frame joining the opposed, exterior sides, the cylinder rods passing through a rod aperture in the mold frame, the cylinder rods perpendicular to the cavity vertical interior sides;
(d) a core bar mounting bracket fastened between the cylinder rods; and
(e) at least one core bar reversibly secured to the mounting bracket and extending toward the mold cavity through a core bar aperture in the mold frame, whereby the at least one core bar is removed from the mold cavity with the cylinder rods extended and traverses the mold cavity with the cylinder rods retracted.

20. The core puller/mold assembly of claim 19, wherein the at least one core bar is positioned adjacent one surface of the block mold.

21. The core puller/mold assembly of claim 19, wherein two core bars are secured to the core bar mounting bracket.

22. A method of molding a concrete block comprising the steps;
(a) providing a core puller/mold assembly comprising a mold frame containing a block mold having a mold cavity; a pair of cylinders, with each cylinder fastened to an opposed, exterior side of the mold frame; the cylinders each having a rod extending beyond the mold frame joining the opposed, exterior sides; a core bar mounting bracket fastened between the cylinder rods; and at least one core bar secured to the mounting bracket, with the bar extending toward the mold cavity,
(b) retracting the cylinder rods with the at least one core bar traversing the mold cavity;
(c) filling the mold with fill mix;
(d) vibrating and pressurizing the mold assembly to form the block within the mold cavity;
(e) removing the at lease one core bar from the mold cavity by extending the cylinder rods; and
(f) removing the block vertically from the mold cavity.
